(19) United States
(12) Patent Application Publication
(10) Pub. No.: US 2014/0171306 A1
(43) Pub. Date: Jun. 19, 2014

(54) ADSORBENT AND METHOD OF PRODUCING THE ADSORBENT

(71) Applicant: FUJITSU LIMITED, Kawasaki-shi (JP)

(72) Inventors: Toshio MANABE, Atsugi (JP); Hiroaki Yoshida, Isehara (JP); NORIYASU ASO, ISEHARA (JP)

(73) Assignee: FUJITSU LIMITED, Kawasaki-shi (JP)

(21) Appl. No.: 14/189,149

(22) Filed: Feb. 25, 2014

Related U.S. Application Data
(63) Continuation of application No. PCT/JP2011/069572, filed on Aug. 30, 2011.

(51) Int. Cl. B01J 20/30; B01J 20/20

(52) U.S. Cl. CPC B01J 20/3085; B01J 20/20
USPC 502/437; 502/418; 502/416

(57) ABSTRACT

Disclosed is a method of producing an adsorbent. The method includes hydrophilizing a surface of activated carbon with an oxidizing agent, and immersing the activated carbon in a solution of a basic compound.

### CROSS-REFERENCE TO RELATED APPLICATION

This application is a continuation application of International Application PCT/JP2011/69572 filed on Aug. 30, 2011 and designated the U.S., the entire contents of which are incorporated herein by reference.

### FIELD

The embodiments discussed herein are related to an adsorbent and a method of producing the adsorbent.

### BACKGROUND

Along with the momentum toward the prevention of global warming and the conservation of energy resources, techniques that reutilize waste heat of factories, server rooms, and the like to reduce environmental loads are attracting attention.

An adsorption heat pump is one of such techniques that collect waste heat. In an adsorption heat pump, a cooling medium is adsorbed to an adsorbent in an adsorption cycle. Then, in a cycle called a desorption cycle, the cooling medium is desorbed from the adsorbent by the heat of hot water carrying waste heat. In this desorption cycle, since the adsorbent absorbs the heat, the hot water is cooled to be made into cool water. With the cool water, servers or the like can be cooled.

On the other hand, in the adsorption cycle, the cooling medium in an evaporator is evaporated to generate vapor of the cooling medium, and the vapor is adsorbed to the adsorbent. The heat of evaporation generated when the cooling medium is evaporated provides cold energy. The cold energy can be used to supply cooling air into a server room or the like. In this way, the collected waste heat can be effectively utilized.

Note that techniques related to the present application are disclosed in Japanese Laid-open Patent Publications No. 07-80292

### SUMMARY

According to an aspect of the embodiments, a method of producing an adsorbent includes hydrophilizing a surface of activated carbon with an oxidizing agent, and immersing the activated carbon in a solution of a basic compound.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a cross-sectional view of an adsorption heat pump;

FIG. 2 is a diagram for explaining the adsorption isotherm of activated carbon;

FIGS. 3A to 3C are schematic views for explaining a method of producing an adsorbent according to an embodiment;

FIG. 4 is a schematic diagram depicting changes in the adsorption isotherm of the activated carbon as a result of performing processes in FIGS. 3A to 3C;

FIG. 5 is the adsorption isotherm of activated carbon obtained in a first example;

FIG. 6 is the adsorption isotherm of activated carbon obtained in a second example;

FIG. 7 is the adsorption isotherm of activated carbon obtained in a third example;

FIG. 8 is the adsorption isotherm of activated carbon obtained in a fourth example;

FIG. 9 is the adsorption isotherm of activated carbon obtained in a fifth example;

FIG. 10 is the adsorption isotherm of activated carbon obtained in a sixth example;

FIG. 11 is total ion chromatograms depicting a state of the surface of activated carbon;

FIG. 12 is a graph depicting the amounts of acidic functional groups on the surface of the activated carbon; and

FIG. 13 is a view schematically illustrating the state of the surface of the activated carbon.

### DESCRIPTION OF EMBODIMENTS

Before describing an embodiment, a preliminary matter which forms the basis of the embodiment will be described.

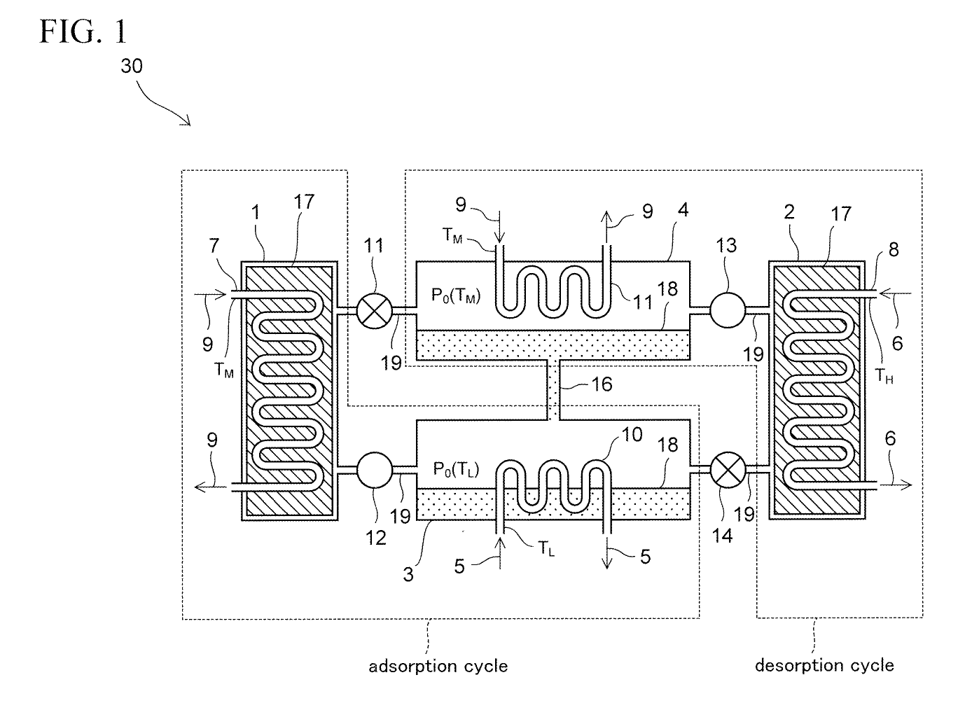

FIG. 1 is a cross-sectional view of an adsorption heat pump.

This adsorption heat pump 30 includes a first adsorber 1, a second adsorber 2, an evaporator 3, a condenser 4, and a plurality of connection pipes 19, each of which is depressurized.

The connection pipes 19 are used to connect the first adsorber 1 and the evaporator 3, and to connect the first adsorber 1 and the condenser 4. Further, the connection pipes 19 are also used to connect the second adsorber 2 and the evaporator 3, and to connect the second adsorber 2 and the condenser 4.

On the other hand, activated carbon 17 is housed as an adsorbent in each of the first adsorber 1 and the second adsorber 2. Water 18 is housed in the evaporator 3.

Moreover, a first pipe 7 is provided in the first adsorber 1, and cooling water 9 at a temperature T_{M} is supplied to the first pipe 7.

In addition, a second pipe 8 is provided in the second adsorber 2, and hot water 6 at a temperature T_{H} is supplied to the second pipe 8. The hot water 6 serves to carry waste heat generated by electronic devices such as servers and circulates between the adsorption heat pump 30 and a server room.

On the other hand, a third pipe 10 is provided in the evaporator 3, and a circulating fluid 5 is supplied to the third pipe 10. The circulating fluid 5, such as water, is aimed to be cooled in this example. The circulating fluid 5 circulates between the adsorption heat pump 30 and the server room, and is used for cooling the server room and for other purposes.

Further, a fourth pipe 11 is provided in the condenser 4, and the cooling water 9 at the temperature T_{M} is supplied to the fourth pipe 11.

Moreover, the evaporator 3 and the condenser 4 are connected to each other by a drain pipe 16, through which water 18 can flow from the condenser 4 to the evaporator 3.

In addition, first to fourth valves 11 to 14 are provided to the connection pipes 19, respectively. By switching the open and close state of the valves 11 to 14, the adsorption cycle and the desorption cycle can be switched in the adsorption heat pump 30.

For example, in the open and close state of the valves depicted in FIG. 1, the adsorption cycle is performed in the first adsorber 1, and the desorption cycle is performed in the second adsorber 2.

Vapor of the water 18 evaporated in the evaporator 3 is supplied via the second valve 12 to the first adsorber 1 in which the adsorption cycle is performed, and the vapor gets adsorbed by the activated carbon 17. Heat generated in the activated carbon 17 during the adsorption is cooled by the cooling water 9 flowing in the inner pipe 7, so that the adsorption of the water 18 by the activated carbon 17 is promoted.

In this process, in the evaporator 3, the heat of evaporation of the water 18 cools the circulating fluid 5, and thereby generates cold energy. The cold energy is used to supply cooling air to the server room and racks, for example.

On the other hand, in the second adsorber 2 in which the desorption cycle is performed, the heat of the hot water 6 causes the water 18 to desorb from the activated carbon 17. In this process, the activated carbon 17 absorbs the heat and thereby cools the hot water 6.

Then, the hot water 6 thus cooled returns to the server room and is used to cool the electronic devices again.

Moreover, the water 18 desorbed from the activated carbon 17 in the second adsorber 2 moves via the third valve 13 to the condenser 4. In the condenser 4, the cooling water 9 draws heat from the water 18, thereby condensing the water 18. Thereafter, the water 18 passes through the drain pipe 16 and returns to the evaporator 3 again.

In this series of processes, the heat of the hot water 6 causes the water 18 to desorb from the activated carbon 17 in the second adsorber 2. Further, the heat of evaporation of the water 18 in the evaporator 3 cools the circulating fluid 5. Thus, the heat of the hot water 6 is reutilized to generate the cold energy of the circulating fluid 5.

Here, the efficiency of operation of the above-described adsorption heat pump 30 depends on the temperature T_{H} of the hot water 6 and the temperature T_{M} of the cooling water 9.

For example, by setting the temperature T_{H} of the hot water 6 to a high value, the water 18 quickly desorbs from the activated carbon 17 in the second adsorber 2 in the desorption cycle, so that the efficiency of operation of the adsorption heat pump 30 can be increased.

Moreover, by setting the temperature T_{M} of the cooling water 9 to a low value, the activated carbon 17 generating heat in the first adsorber 1 in the adsorption cycle is efficiently cooled, thereby promoting the adsorption of the water 18 by the activated carbon 17, so that the efficiency of operation of the adsorption heat pump 30 can be increased.

However, setting the temperature T_{H} of the hot water 6 to a high value narrows the range of choice for the waste heat to be reutilized and makes it impossible to reutilize waste heat of automobiles and computers which generate low amounts of heat.

Also, the temperature T_{M} of the cooling water 9 varies from one season to another. In particular, in summer, the temperature T_{M} become high, and hence the improvement in the efficiency of operation of the adsorption heat pump 30 by the reduction in the temperature of the cooling water 9 cannot be expected in some cases.

Thus, the adsorption heat pump 30 is desired to be capable of efficiently collecting waste heat and generating cold energy even when the temperature T_{H} of the hot water 6 is low and the temperature T_{M} of the cooling water 9 is high.

The efficiency of collecting waste heat depends on properties of the activated carbon 17. The higher the humidity of the ambient air, the more water the activated carbon 17 adsorbs. The lower the humidity of the ambient air, the less water the activated carbon 17 adsorbs.

Note that since the humidity depends on the temperature of the air, a relative vapor pressure Pᵣ is used in the followings instead of humidity.

The relative vapor pressure Pᵣ is defined as P/P₀, where P denotes a vapor pressure of the water contained in the air at a given temperature, and P₀ denotes a saturated vapor pressure P₀ of the water at that temperature. Since the saturated vapor pressure P₀ is used as a reference in this definition, the relative vapor pressure Pᵣ serves as an index indicating the humidity in the air irrespective of the temperature.

The value of the relative vapor pressure Pᵣ in the adsorption heat pump 30 is different between the desorption cycle and the adsorption cycle as described below.

When the adsorption cycle is performed in the first adsorber 1 as depicted in FIG. 1, the temperature in the first adsorber 1 is substantially equal to the temperature T_{M} of the cooling water 9.

Moreover, in the evaporator 3, the temperature of the water 18 can be deemed as being substantially equal to a temperature T_{L} of the circulating fluid 5, and the water 18 can be deemed as being in vapor-liquid equilibrium at the temperature T_{L}. Therefore, the vapor pressure in the evaporator 3 can be considered to be equal to the saturated vapor pressure P₀(T_{L}) at the temperature T_{L}.

Moreover, the vapor pressure in the first adsorber 1 communicating with the evaporator 3 via the second valve 12 becomes equal to the saturated vapor pressure P₀(T_{L}) as well. Thus, using a saturated vapor pressure P₀(T_{M}) at the temperature T_{M}, a relative vapor pressure Pᵣ₁ in the first adsorber 1 is equal to P₀(T_{L})/P₀(T_{M})

On the other hand, the temperature of the inside of the second adsorber 2 operating in the desorption cycle is substantially equal to the temperature T_{H} of the hot water 6.

Further, in the condenser 4, the temperature of the water 18 can be deemed as being substantially equal to the temperature T_{M} of the cooling water 9, and the water 18 can be deemed as being in vapor-liquid equilibrium at the temperature T_{M}. Thus, the vapor pressure in the condenser 4 can be considered to be equal to a saturated vapor pressure P₀(T_{M}) at the temperature T_{M}.

Furthermore, the vapor pressure in the second adsorber 2 communicating with the condenser 4 via the third valve 13 becomes equal to the saturated vapor pressure P₀(T_{M}) as well. Thus, a relative vapor pressure Pᵣ₂ in the second adsorber 2 in the desorption cycle is equal to P₀(T_{M})/P₀(T_{H}).

In this manner, the relative vapor pressure Pᵣ₁ (=P₀(T_{L})/P₀(T_{M})) in the adsorption cycle and the relative vapor pressure Pᵣ₂ (=P₀(T_{M})/P₀(T_{H})) in the desorption cycle can be calculated from the saturated vapor pressures of the water at the temperatures T_{L}, T_{M}, and T_{H}.

These temperatures T_{L}, T_{M}, and T_{H} are values set at the time of designing the adsorption heat pump 30 and are not particularly limited.

However, the temperature T_{M} of the cooling water 9 is preferably set to be as high as 25° C. to 30° C., in consideration of the temperature increase in summer as mentioned above.

Moreover, the temperature T_{H} of the hot water 6 is preferably set to be as low as possible, e.g. about 50° C. to 60° C. so as to broaden the range of choice for the waste heat to be reutilized.

Further, the temperature T_{L} of the circulating fluid 5 is preferably set to approximately 18° C. so that cold air generated by the circulating fluid 5 can sufficiently cool the server room.

When the temperatures T_{L}, T_{M}, and T_{H} are set to the above values, the relative vapor pressure Pᵣ₁ in the adsorption cycle becomes approximately 0.5, and the relative vapor pressure Pᵣ₂ in the desorption cycle becomes approximately 0.2.

The activated carbon 17 adsorbs and desorbs the water under the condition where the relative vapor pressure is in a range between Pᵣ₂ and Pᵣ₁ mentioned above. By causing the activated carbon 17 to adsorb a large amount of water in this range, the efficiency of operation of the adsorption heat pump 30 can be increased.

The amount of water adsorbed by activated carbon can be explained by an adsorption isotherm.

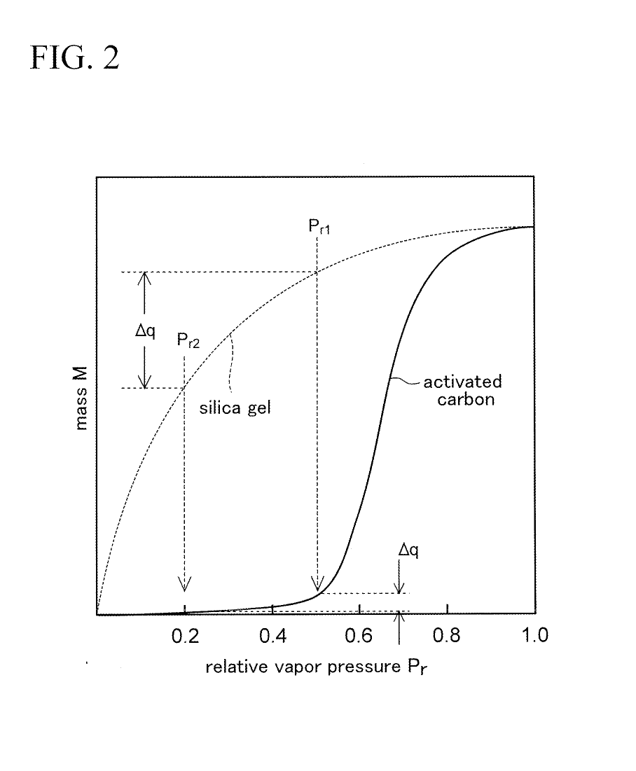

FIG. 2 is a diagram for explaining the adsorption isotherm of activated carbon.

The adsorption isotherm depicts the relationship between the relative vapor pressure Pᵣ and a mass M of water that is adsorbed by the activated carbon of unit mass.

FIG. 2 exemplarily depicts the adsorption isotherm of commercially available general activated carbon with a solid line. As depicted in FIG. 2, when the relative vapor pressure Pᵣ is near 0, there is only a small amount of moisture to adsorb around the activated carbon, and therefore the mass M of water adsorbed by the activated carbon is small.

As the relative vapor pressure Pᵣ increases, the mass M of water adsorbed by the activated carbon increases as well, and the mass M becomes largest when the relative vapor pressure Pᵣ reaches 1.

Here, the surface of the commercially available activated carbon is hydrophobic, and hence it is difficult for water to be adsorbed to the activated carbon. Thus, the adsorption isotherm rises steeply after the relative vapor pressure Pᵣ exceeds 0.5, whereas an amount Δq of water adsorbed by the activated carbon is extremely small when the relative vapor pressure Pᵣ is in the range between Pᵣ₂ and Pᵣ₁.

Therefore, when the commercially available activated carbon 17 is used without any treatment, the efficiency of operation of the adsorption heat pump 30 cannot be increased.

Note that instead of the activated carbon 17, it might be considered that silica gel or zeolite is used as the adsorbent.

The dotted line in FIG. 2 is the adsorption isotherm of silica gel. The adsorption isotherm of zeolite shows similar tendency like this.

The surface of silica gel is hydrophilic. Therefore, as compared to the activated carbon having a hydrophobic surface, a large amount of water can be adsorbed to silica gel even when the relative vapor pressure is low.

However, when the surface is hydrophilic, it is difficult for water from desorbing from the surface. Thus, in this case too, the amount Δq of the adsorbed water cannot be sufficiently increased when the relative vapor pressure is in the range between Pᵣ₂ and Pᵣ₁.

In view of these findings, the inventors of the present application conceived of an embodiment described below.

### Embodiment

First, the principle of the embodiment will be described.

In order to increase the amount Δq of water adsorbable and desorbable by activated carbon when the relative vapor pressure is in the range between Pᵣ₂ and Pᵣ₁, it is considered to be effective to control the shape of the adsorption isotherm of the activated carbon in a manner that a region of the adsorption isotherm having large slope falls within the range between Pᵣ₂ and Pᵣ₁.

As depicted in FIG. 2, the shape of the adsorption isotherm differs between activated carbon having a hydrophobic surface and silica gel having a hydrophilic surface.

Hence, when the surface of the activated carbon, which is originally hydrophobic, is hydrophilized, changing the shape of the adsorption isotherm of the activated carbon is considered possible. However, when the entire surface of the activated carbon is completely hydrophilized, it becomes difficult to desorb the adsorbed water as in the case of silica gel, and hence the amount Δq of water to be desorbed cannot possibly be increased to a sufficient extent.

In view of this, in this embodiment, the shape of the adsorption isotherm of the activated carbon is controlled by controlling the degree of hydrophilization of the surface as described below.

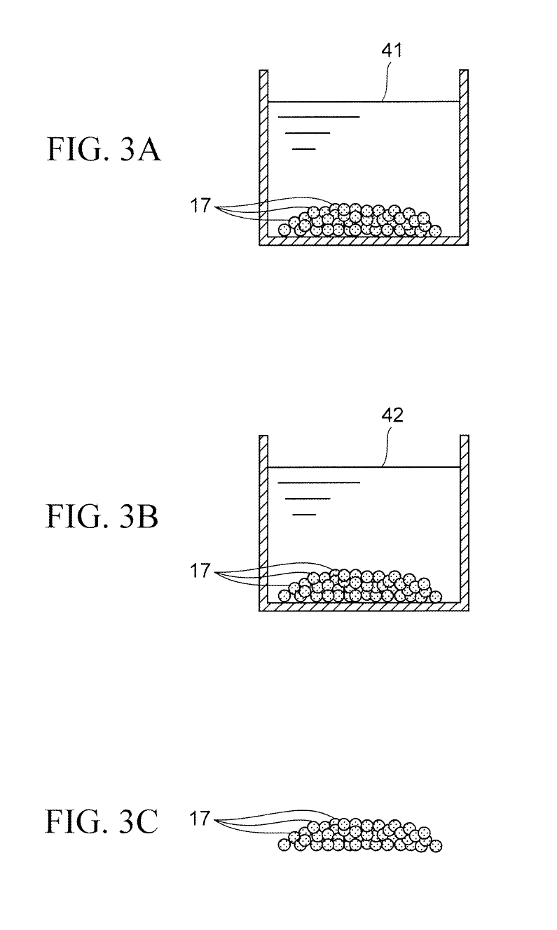

FIGS. 3A to 3C are schematic views for explaining a method of producing the adsorbent according to this embodiment.

First, as depicted in FIG. 3A, activated carbon 17 produced by carbonizing phenol resin or petroleum pitch is immerse into an oxidizing agent 41.

The specific surface area of one piece of the activated carbon 17 is not particularly limited. However, in view of increasing the water adsorbing to the activated carbon 17 in the first adsorber 1 and the second adsorber 2 (see FIG. 1), it is preferable that the specific surface area of the activated carbon 17 be 1000 m²/g or larger.

The shape of the activated carbon 17 is also not limited. In this embodiment, spherical activated carbon 17 is used so that the activated carbon 17 can be filled in the first adsorber 1 and the second adsorber 2 as much as possible. The diameter of the activated carbon 17 is about 0.3 mm to 0.5 mm, for example.

The oxidizing agent 41 is also not particularly limited. However, the oxidizing agent 41 is preferably to be such a solution that has a property of allowing hydrophilic groups such as carboxyl groups and hydroxyl groups to bond to the surface of the activated carbon 17. As such an oxidizing agent 41, any of a nitric acid solution, a mixed solution of nitric acid and sulfuric acid, a sodium hypochlorite aqueous solution, and bromine water is available.

By using one of these solutions, the hydrophilic groups are bonded to the surface of the activated carbon 17, and a part of the surface of the activated carbon 17 becomes hydrophilized.

Note that before the immersion in the oxidizing agent 41, the activated carbon 17 may be dried in advance in a vacuum at a temperature of 150° C. to remove impurities attached to the surface of the activated carbon 17. By this drying process, it is prevented that the hydrophilic groups is difficult to be bonded to the surface of the activated carbon 17 due to the impurities.

In particular, the activated carbon 17 made of phenol resin or petroleum pitch contains a smaller amount of impurities such as metals than those produced from a plant such as coconut husk activated carbon that is frequently used as a deodorizer, and is therefore suitable for bonding the hydrophilic groups to its surface.

Thereafter, the activated carbon 17 is taken out of the oxidizing agent 41. After that, the activated carbon 17 is rinsed with pure water, and then is dried.

Subsequently, as depicted in FIG. 3B, the activated carbon 17 is immersed in a basic compound solution 42. The basic compound contained in the solution 42 is not particularly limited. However, a nitrogen-containing hetero compound having a property that allows hydrophobization of the surface of the activated carbon 17 is preferably used as the basic compound.

As the nitrogen-containing hetero compound having such a property, any of pyridine, pyrazine, quinoline, indole, and phenanthroline is available, for example. Moreover, ammonia is also preferable as the basic compound.

By immersing the activated carbon 17 in the solution 42 of one of these basic compounds, a part of the surface of the activated carbon 17, which is hydrophilized in the step in FIG. 3A, can be hydrophobized. Thus, the surface of the activated carbon 17 can be prevented from being excessively hydrophilized.

Thereafter, the activated carbon 17 is dried as depicted in FIG. 3C, thus the basic steps for the method of producing the adsorbent according to this embodiment are completed.

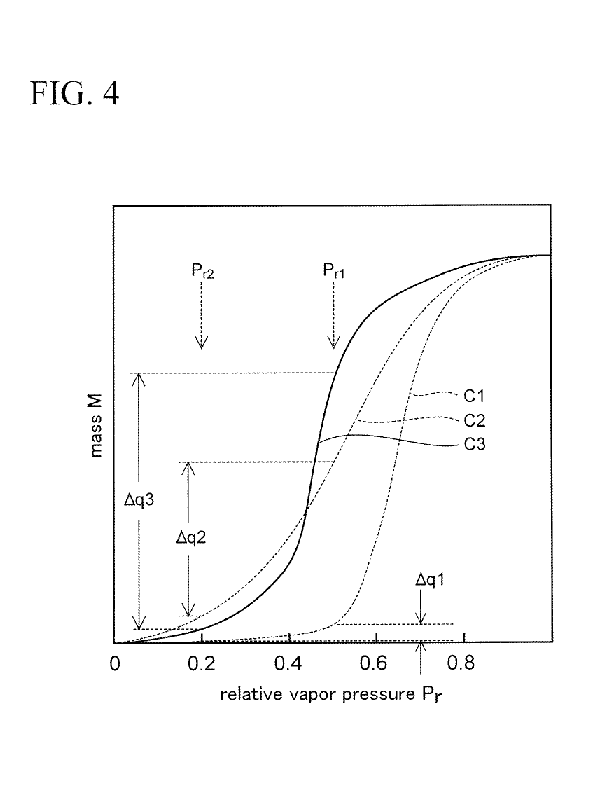

FIG. 4 is a schematic diagram depicting changes in the adsorption isotherm of the activated carbon 17 as a result of performing the processes in FIGS. 3A to 3C.

In FIG. 4, a curve C1 is the adsorption isotherm of unprocessed activated carbon 17. A curve C2 is the adsorption isotherm of activated carbon 17 to which only the hydrophilization step in FIG. 3A is performed and for which the hydrophobization step in FIG. 3B is omitted.

Moreover, a curve C3 is the adsorption isotherm of activated carbon 17 to which both the hydrophilization step in FIG. 3A and the hydrophobization step in FIG. 3B are performed.

As depicted in FIG. 4, the slope of the adsorption isotherm C1 of the unprocessed activated carbon 17 is small in a region where the relative vapor pressure is equal to or lower than Pᵣ₁, and an amount Δq1 of the adsorbed water in the region where the relative vapor pressure is between Pᵣ₂ and Pᵣ₁ is extremely small.

On the other hand, as depicted by the adsorption isotherm C3, in the case where both the hydrophilization step and the hydrophobization step are performed as in this embodiment, an amount Δq3 of the adsorbed water in the region where the relative vapor pressure is between Pᵣ₂ and Pᵣ₁ is larger than that in the case where no processes are performed.

This is because the hydrophilization step in FIG. 3C makes it easy for the activated carbon 17 to adsorb water, so that the slope of the adsorption isotherm C3 in the region where the relative vapor pressure is equal to or lower than Pᵣ₁ is increased as compared to the case where no processes are performed.

On the other hand, as depicted by the adsorption isotherm C2, in the case where the hydrophobization step is omitted, an amount Δq2 of the adsorbed water in the region where the relative vapor pressure is between Pᵣ₂ and Pᵣ₁ is decreased as compared to the adsorption isotherm C3 of this embodiment. This is because the surface of the activated carbon 17 is hydrophilized more than necessary as a result of omitting the hydrophobization step (FIG. 3B), so that the adsorption isotherm C2 rises steeply around a point where the relative vapor pressure is 0.

From the above result, it is revealed that performing both the hydrophilization step and the hydrophobization step as in this embodiment makes it possible to suppress the steep rise in the adsorption isotherm and also to obtain the adsorption isotherm C3 having a preferable shape for increasing the amount of water adsorbed by the activated carbon 17.

Moreover, by controlling the shape of the adsorption isotherm C3 in this manner, a portion of the adsorption isotherm C3 which has a large slope can be located within the region where the relative vapor pressure is between the Pᵣ₂ and Pᵣ₁. Thus, the activated carbon 17 can adsorb a large amount of water, and hence the efficiency of the adsorption heat pump 30 can be increased.

Accordingly, lower temperature heat can be used as the waste heat to be carried by the hot water 6. As a result, the adsorption heat pump can be applied to apparatuses that have low temperature waste heat, such as automobiles and computers. Thus, by collecting waste heat generated from these apparatuses, it is made possible to achieve energy saving and reduction in environmental load.

Moreover, even when the temperature of the cooling water 9 becomes high, the efficiency of operation of the adsorption heat pump 30 does not decrease. Therefore, the range of application of the adsorption heat pump 30 can be further widened.

Next, examples of this embodiment will be described.

### FIRST EXAMPLE

In this example, granular activated carbon with a specific surface area of 1200 m²/g is used as the activated carbon 17. This activated carbon 17 was obtained by carbonizing petroleum pitch. Then, the steps in FIGS. 3A to 3C were performed on this activated carbon 17.

A mixed acid of sulfuric acid and nitric acid was used as the oxidizing agent 41 (see FIG. 3A). In this mixed acid, the volume ratio of the sulfuric acid to the nitric acid was 3:1. The activated carbon 17 was immersed in this mixed acid for three hours.

Moreover, pyridine was used as the basic compound solution 42 (see FIG. 3B), and the activated carbon 17 was immersed in the pyridine for five hours.

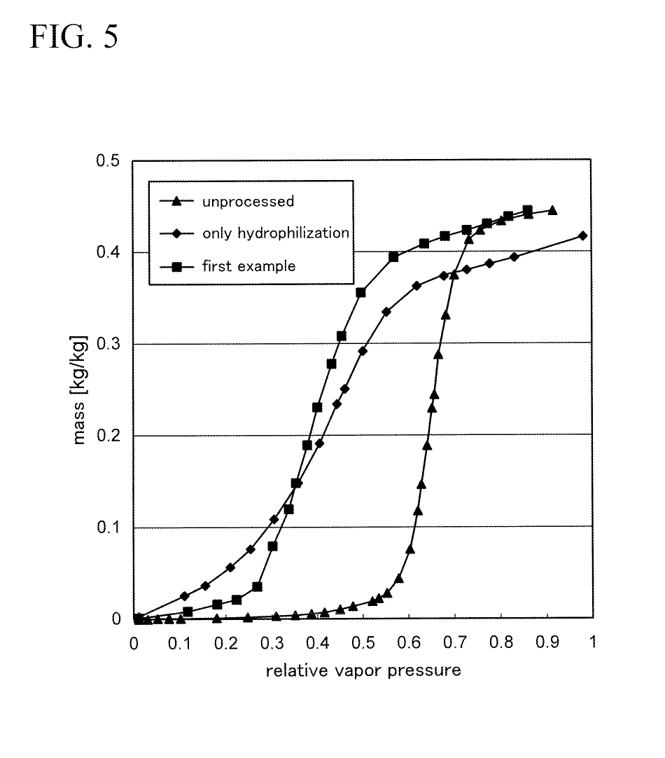

FIG. 5 depicts the adsorption isotherm of the activated carbon 17 thus obtained at 30° C.

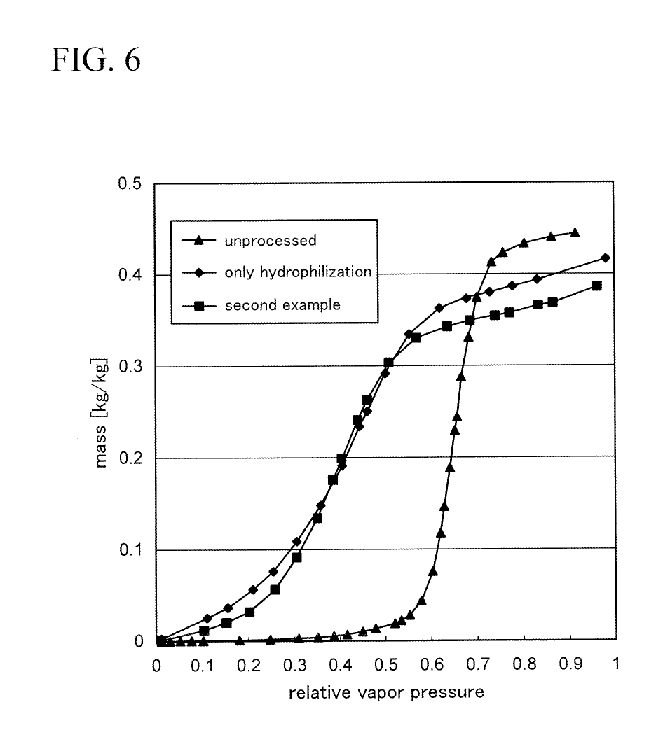

FIG. 5 also depicts the adsorption isotherm of unprocessed activated carbon 17. Also, FIG. 5 also depicts the adsorption isotherm of activated carbon 17 to which only the hydrophilization process in FIG. 3A was performed and the hydrophobization process in of FIG. 3B was not performed. This is also the case for the FIGS. 6 to 10 in the followings.

In this example, when the relative vapor pressures Pᵣ₂ and Pᵣ₁ were set at 0.2 and 0.5 respectively, the amount of water adsorbed by the activated carbon 17 was 0.34 kg/kg in the range between Pᵣ₁ and Pᵣ₂. The value 0.34 kg/kg is larger than those obtained by performing no processes or performing only the hydrophilization process.

### SECOND EXAMPLE

In this example, a methanolic pyrazine solution was used as the basic compound solution 42 (see FIG. 3B), and the activated carbon 17 was immersed in that solution for five hours in the hydrophobization process. The other conditions in this example were the same as those in the first example.

FIG. 6 depicts the adsorption isotherm of the activated carbon 17 obtained in this example at 30° C.

In this example, when the relative vapor pressures Pᵣ₂ and Pᵣ₁ were set at 0.2 and 0.5 respectively, the amount of water adsorbed by the activated carbon 17 was 0.26 kg/kg in the range between Pᵣ₁ and Pᵣ₂. The value 0.26 kg/kg is larger than those obtained by performing no processes or performing only the hydrophilization process.

### THIRD EXAMPLE

In this example, ammonia water was used as the basic compound solution 42 (see FIG. 3B), and the activated carbon 17 was immersed in that ammonia water for five hours in the hydrophobization process. The other conditions in this example were the same as those in the first example.

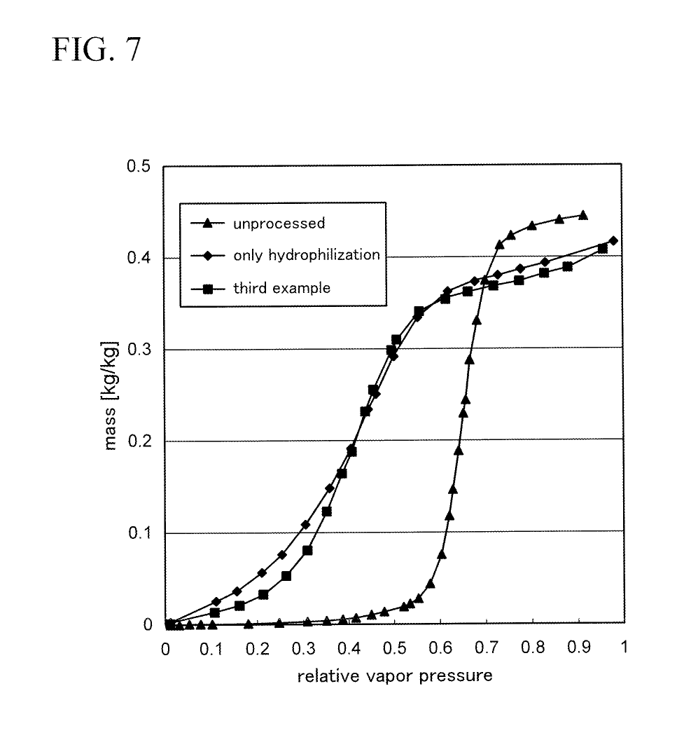

FIG. 7 depicts the adsorption isotherm of the activated carbon 17 obtained in this example at 30° C.

In this example, when the relative vapor pressures Pᵣ₂ and Pᵣ₁ set at 0.2 and 0.5 respectively, the amount of water adsorbed by the activated carbon 17 was 0.27 kg/kg in the range between Pᵣ₁ and Pᵣ₂. The value 0.27 kg/kg is larger than those obtained by performing no processes or performing only the hydrophilization process.

### FOURTH EXAMPLE

In this example, granular activated carbon with a specific surface area of 1300 m²/g obtained by carbonizing phenol resin was used as the activated carbon 17. The other conditions in this example were the same as those in the first example.

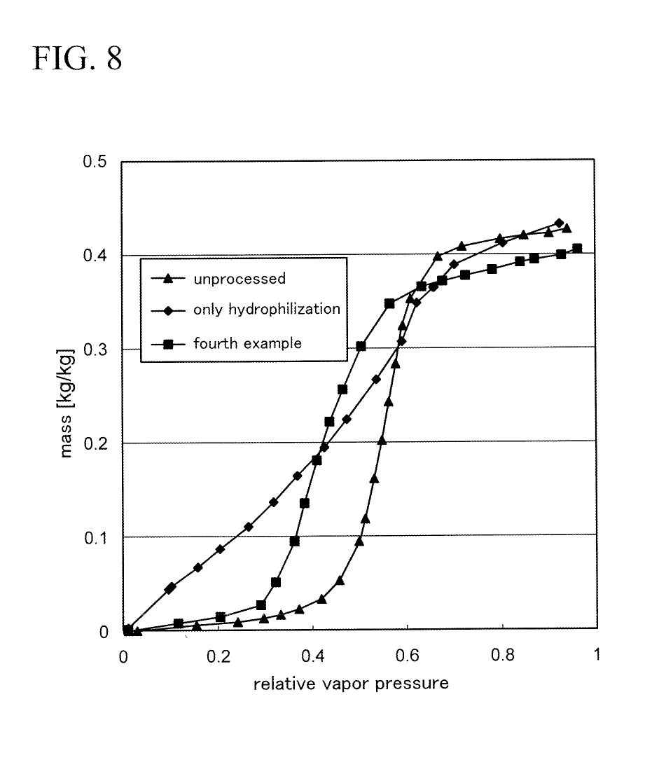

FIG. 8 depicts the adsorption isotherm of the activated carbon 17 obtained in this example at 30° C.

In this example, when the relative vapor pressures Pᵣ₂ and Pᵣ₁ were set at 0.2 and 0.5 respectively, the amount of water adsorbed by the activated carbon 17 was 0.29 kg/kg in the range between Pᵣ₁ and Pᵣ₂. The value 0.29 kg/kg is larger than those obtained by performing no processes or performing only the hydrophilization process.

### FIFTH EXAMPLE

In this example, granular activated carbon with a specific surface area of 1300 m²/g obtained by carbonizing phenol resin was used as the activated carbon 17. The other conditions in this example were the same as those in the second example.

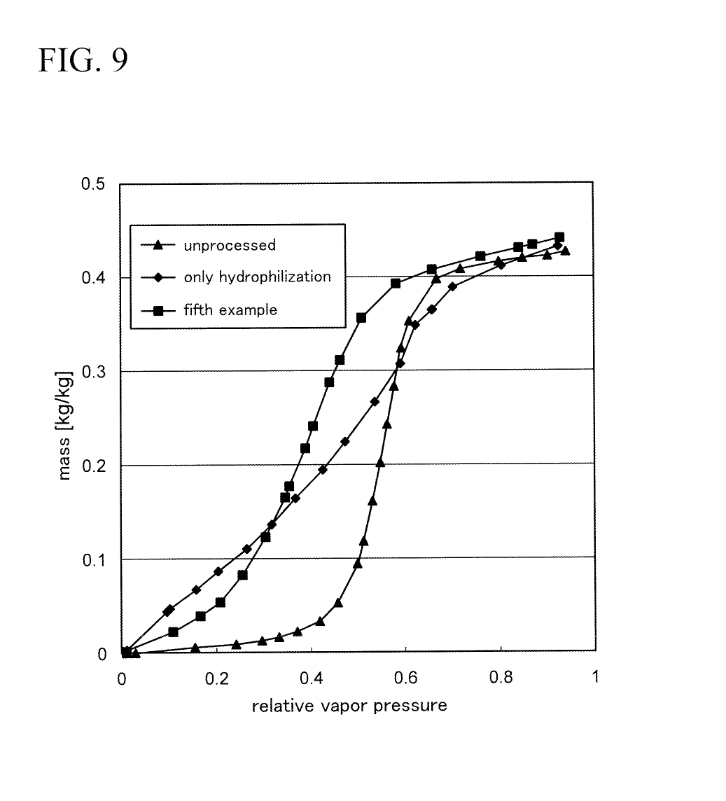

FIG. 9 depicts the adsorption isotherm of the activated carbon 17 obtained in this example at 30° C.

In this example, when the relative vapor pressures Pᵣ₂ and Pᵣ₁ were set at 0.2 and 0.5 respectively, the amount of water adsorbed by the activated carbon 17 was 0.30 kg/kg in the range between Pᵣ₁ and Pᵣ₂. The value 0.30 kg/kg is larger than those obtained by performing no processes or performing only the hydrophilization process.

### SIXTH EXAMPLE

In this example, granular activated carbon with a specific surface area of 1300 m²/g obtained by carbonizing phenol resin was used as the activated carbon 17. The other conditions in this example were the same as those in the third example.

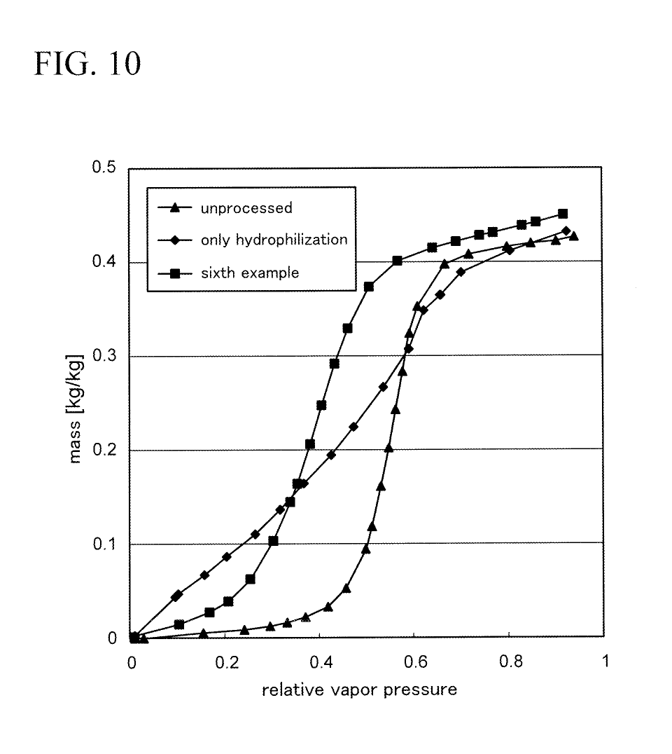

FIG. 10 depicts the adsorption isotherm of the activated carbon 17 obtained in this example at 30° C.

In this example, when the relative vapor pressures Pᵣ₂ and Pᵣ₁ were set at 0.2 and 0.5 respectively, the amount of water adsorbed by the activated carbon 17 was 0.33 kg/kg in the range between Pᵣ₁ and Pᵣ₂. The value 0.33 kg/kg is larger than those obtained by performing no processes or performing only the hydrophilization process.

(Evaluation Results)

The inventors of the present application evaluated a state of the surface of the activated carbon produced according to the present embodiment. The evaluation results will be described below.

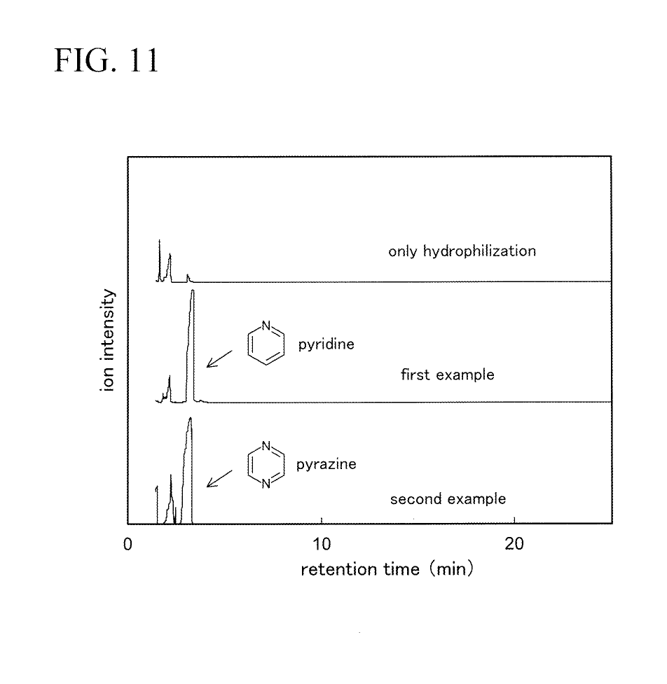

FIG. 11 is total ion chromatograms obtained by GC/MS (gas chromatography/mass spectrometry). The horizontal axis of FIG. 11 indicates retention time, and the horizontal axis indicates ion intensity.

The subjects of the evaluation by the total ion chromatograms were (i) the activated carbon 17 obtained by performing only the hydrophilization process, (ii) the activated carbon 17 obtained in the first example, and (iii) the activated carbon 17 obtained in the second example.

As depicted in FIG. 11, a peak which was not observed in the case where only the hydrophilization process was performed, was observed in the first example and the second example. The peak in the first example was identified as pyridine, and the peak in the second example was identified as pyrazine.

As mentioned earlier, pyridine and pyrazine are the basic compounds used in the first example and the second example respectively. Moreover, in this evaluation, the activated carbon 17 was dried at a temperature of 150° C. in a vacuum as pretreatment. Therefore, pyridine and pyrazine are considered to be caught on the surface of the activated carbon 17 by strong interaction with the activated carbon 17.

Thus, it is revealed that the activated carbon produced according to the present embodiment is brought into a state where the basic compound in the solution 42 is bonded to the surface of the activated carbon 17.

The inventors of the present application also conducted a quantitative analysis of acidic functional groups to find how the chemical composition of the surface of the activated carbon 17 was changed by the present embodiment. The quantitative analysis was conducted in accordance with the method described in H. P. Boehm, Angew Chem. 78, 617 (1966).

The subjects of the evaluation were (i) the unprocessed activated carbon 17, (ii) the activated carbon 17 obtained by performing only the hydrophilization process, and (iii) the activated carbon 17 obtained in the first example. A 0.1 N solution of sodium hydrogen carbonate, a 0.1 N solution of sodium carbonate, and a 0.1 N solution of sodium hydroxide were prepared, and the activated carbon 17 was immersed in these solutions. Thereafter, filtrate of each solution was back titrated with 0.1 N hydrochloric acid to determine the amounts of the acidic functional groups such as carboxyl groups, lactone, and phenolic hydroxyl groups.

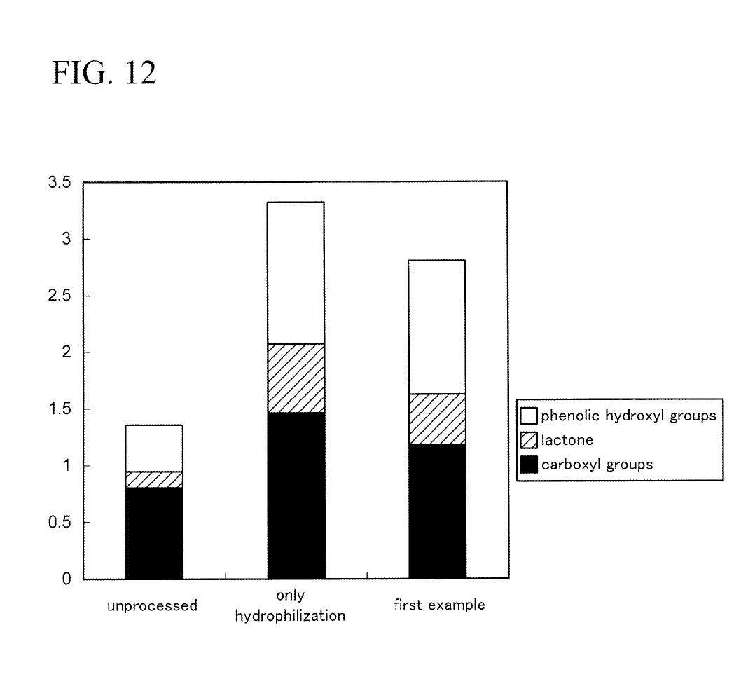

FIG. 12 is a graph depicting the amounts of the acidic functional groups evaluated in this manner. Vertical axis of FIG. 12 indicates the milliequivalents of each acidic functional group per gram of the activated carbon.

As depicted in FIG. 12, as compared to the case where no processes were performed, the amount of each acid function group increased greatly in the case where only the hydrophilization process was performed. The acidic functional group thus increased is considered to originate in the oxidizing agent 41 (see FIG. 3A).

On the other hand, as compared to the case where only the hydrophilization process was performed, the amounts of the carboxyl groups and lactone decreased in the case where the activate carbon 17 was immersed in the basic compound solution 42 (see FIG. 3A) after the hydrophilization process as in the first example. This is because the basic compound in the solution 42 is considered to be selectively reacted with a part of the carboxyl groups and lactone.

Note that the amounts of the phenolic hydroxyl groups in the first example were substantially the same as those in the case where only the hydrophilization process was performed.

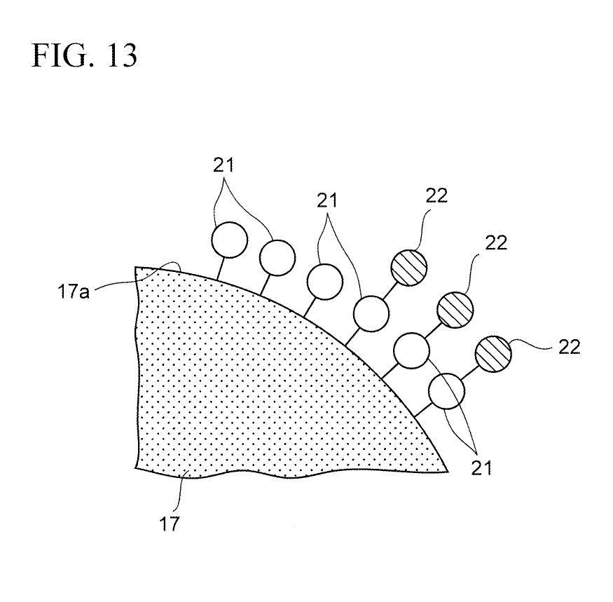

FIG. 13 is a view schematically depicting the state of the surface of the activated carbon 17 deduced from the results in FIGS. 11 and 12.

A plurality of acidic functional groups 21 such as carboxyl groups and lactone are directly bonded to a surface 17a of the activated carbon 17. The surface 17a is considered to be made hydrophilic by these acidic functional groups 21.

Moreover, when a basic compound 22 such as pyridine or pyrazine is bonded to a part of the acidic functional groups 21, the structure in which the basic compound 22 is indirectly bonded to the surface 17a is obtained. Such a structure is assumed to lower the degree of the hydrophilization of the surface 17a.

Note that not all of the acidic functional groups 21 are bonded to the basic compound 22, and a part of the acidic functional groups 21 are not bonded to the basic compound 22. Therefore, it is considered that the effect of the hydrophilization by the acidic functional groups 21 is not lowered excessively.

The present embodiment is described above in detail. However, the present embodiment is not limited to the above. For example, although water is exemplarily described as the cooling medium to be adsorbed and desorbed by the activated carbon 17 in the above, a cooling medium other than water may be used.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method of producing an adsorbent, the method comprising:
hydrophilizing a surface of activated carbon with an oxidizing agent; and
immersing the activated carbon in a solution of a basic compound.

2. The method of producing an adsorbent according to claim 1, wherein the basic compound contains nitrogen.

3. The method of producing an adsorbent according to claim 2, wherein the basic compound is any one selected from the group consisting of pyridine, pyrazine, quinoline, indole, phenanthroline, and ammonia.

4. The method of producing an adsorbent according to claim 1, wherein the oxidizing agent is any one selected from the group consisting of a nitric acid solution, a mixed solution of nitric acid and sulfuric acid, a sodium hypochlorite aqueous solution, and bromine water.

5. The method of producing an adsorbent according to claim 1, wherein the immersing of the activated carbon in the solution is performed after the hydrophilizing of the surface.

6. The method of producing an adsorbent according to claim 1, the method further comprising:
heating the activated carbon in a vacuum before the hydrophilizing of the surface of the activated carbon.

7. The method of producing an adsorbent according to claim 1, wherein the activated carbon is made of either phenol resin or petroleum pitch.

8. An adsorbent comprising:
activated carbon, where a plurality of basic compounds and a plurality of acidic functional groups are bonded directly or indirectly to a surface of the activated carbon.

9. The adsorbent according to claim 8, wherein
the acidic functional groups are directly bonded to the surface of the activated carbon, and
the basic compounds are indirectly bonded to the surface of the activated carbon via the acidic functional groups.

10. The adsorbent according to claim 9, wherein a part of the plurality of acidic functional groups is not bonded to the basic compounds.

11. The adsorbent according to claim 8, wherein the basic compounds are any one selected from the group consisting of pyridine and pyrazine.

12. The adsorbent according to claim 8, wherein the acidic functional groups are any one selected from the group consisting of carboxyl groups, lactone, and phenolic hydroxyl groups.

13. The adsorbent according to claim 8, wherein the activated carbon has a spherical shape.

14. An adsorbent produced by performing:
hydrophilizing a surface of activated carbon with an oxidizing agent; and immersing the activated carbon in a solution of a basic compound.
